(19) United States
(12) Patent Application Publication
(10) Pub. No.: US 2026/0233057 A1
(43) Pub. Date: Aug. 13, 2026

(54) EXERCISE OR REHABILITATION MACHINES AND PEDAL ASSEMBLIES FOR ELECTRICALLY ACTUATING PEDALS

(71) Applicant: ROM TECHNOLOGIES, INC, Brookfield, CT (US)

(72) Inventors: Mark SEROKOSZ, Brookfield, CT (US); Jeff COTE, Brookfield, CT (US)

(21) Appl. No.: 19/160,347

(22) PCT Filed: Feb. 27, 2024
(86) PCT No.: PCT/US2024/017400

§ 371 Date: Aug. 27, 2025

Related U.S. Application Data
(60) Provisional application No. 63/448,905, filed on Feb. 28, 2023.
(60) Provisional application No. 63/448,906, filed on Feb. 28, 2023.
(60) Provisional application No. 63/448,909, filed on Feb. 28, 2023.

(51) Int. Cl. A63B 22/06; A63B 24/00

(52) U.S. Cl. CPC A63B 22/0605; A63B 24/0087; A63B 2022/0647; A63B 2220/13; A63B 2220/833

(57) ABSTRACT

In one embodiment, an exercise or rehabilitation electromechanical device includes a drive sub-assembly, and pedal assemblies secured to opposing sides of the drive sub-assembly by a rotational axle to rotate with the drive sub-assembly, each pedal assembly including a base mounted to the rotational axle to rotate with the drive sub-assembly, rails mounted to the base in parallel, rods coupled to the base in parallel adjacent to but spaced apart from the rails, respectively, a carriage linearly and slidably movable along the rails and the rods, and the carriage has an aperture to couple to a spindle that supports a respective pedal, a motor coupled to the base and operatively coupled to a leadscrew threadingly engaged with the carriage to linearly move the carriage along the rails and rods relative to the base and perpendicular to the rotational axle when the motor is actuated.

### FIELD

The present disclosure relates generally to a pedal and pedal systems for an exercise or rehabilitation machine and, in particular, a pedal that is remotely adjustable during operation.

### BACKGROUND

Improvement is desired in the design of adjustable rehabilitation and exercise devices. Adjustable rehabilitation and exercise devices are desired to customize rehabilitation and exercise to an individual. Some devices include pedals on opposite sides to engage a user. See, e.g., U.S. Pat. No. 10,173,094, titled Adjustable Rehabilitation and Exercise Device, issued to Gomberg, et al., which is hereby incorporated by reference in its entirety.

Accordingly, in one aspect, the disclosure provides an adjustable rehabilitation and exercise device having patient engagement members on opposite sides of the device, which are adjustably positionable relative to one another both radially and angularly.

### BRIEF DESCRIPTION OF THE DRAWINGS

For a more complete understanding of this disclosure and its advantages, reference is now made to the following description, taken in conjunction with the accompanying drawings, in which:

FIG. 1 schematically depicts an exercise machine with an actuatable pedal in accordance with the present disclosure;

FIGS. 2A-2D are schematic views of the exercise machine in accordance with the present disclosure;

FIG. 3 schematically depicts a pedal assembly of the exercise machine of FIG. 1, in accordance with the present disclosure;

FIGS. 4A-4C are various schematic views of the pedal assembly of FIG. 3, in accordance with the present disclosure;

FIG. 4D schematically depicts a cross-sectional view of a motor of the pedal assembly of FIG. 3, in accordance with the present disclosure;

FIG. 5 is a flowchart of a method for operating the rehabilitation/exercise system in accordance with the present disclosure;

FIG. 6 is a schematic view of a pedal and resulting forces in accordance with the present disclosure; and

FIG. 7 is a graph showing the points at which the motor can maintain a set resultant force in accordance with the present disclosure.

### DETAILED DESCRIPTION

In general, embodiments of a pedal or pedal system to be engaged by a user to provide exercise or rehabilitation are disclosed. The pedal can be adjusted in its position using control signals. The control signals can be produced according to an application, which in some example embodiments receives position or force signals from the pedal itself. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the present disclosure. In some example embodiments, well-known processes, well-known device structures, and well-known technologies are not described in detail, as they will be readily understood by the skilled artisan in view of the disclosure herein.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom,” and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

In an aspect, the disclosure provides an adjustable rehabilitation and exercise device having patient engagement members (pedals, handgrips, or the like) on opposite sides of the device, which are adjustably positionable relative to one another radially to provide controlled movement of the members during travel of the engagement members to provide rehabilitation, exercise or both.

In an example embodiment, the pedal mechanism or assembly can be part of a rotary rehabilitation apparatus to provide exercise or movement to a user, e.g., moving joints and activating muscles, tendons, and ligaments. The pedal mechanism can assist in tailoring to the user's needs based upon the user's physical size, type of injury, and treatment schedule. The pedal mechanism can provide for adjustment of the range of motion of the user's extremity in a cycling motion by driving an electrical motor in response to control signals. The control signals can be based on a treatment schedule stored in a controller. The control signals can be based at least in part on sensed characteristics of the pedaling action, e.g., in real time use. The pedals can be moved during a revolution to adjust the travel path to alter the travel path of one or more of the user's limbs from a circular path. The control of the pedal positioning can assist in the rehabilitation of the user by precisely controlling the user's extension and flexion at the user's joints.

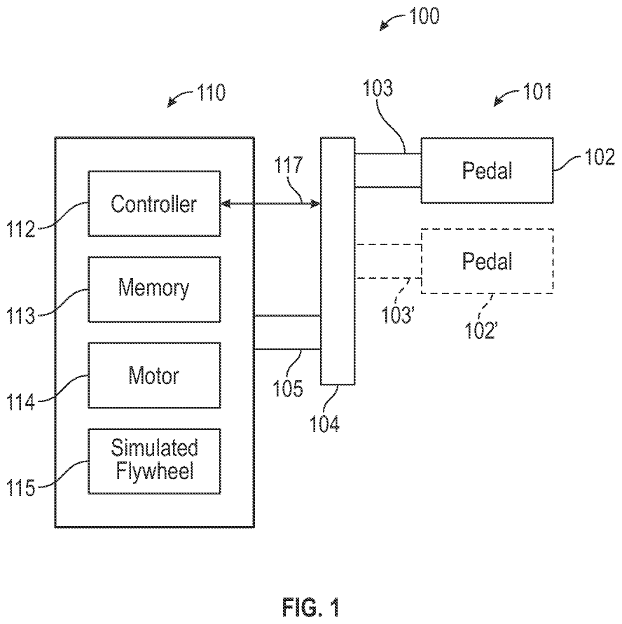

FIGS. 1-7, discussed below, and the various embodiments used to describe the principles of this disclosure are by way of illustration only and should not be construed in any way to limit the scope of the disclosure.

FIG. 1 shows a schematic view of a rehabilitation device 100 that includes a pedal system 101 operably engaged with a base 110, in accordance with the present disclosure. The pedal system 101 includes an engagement member, e.g., a pedal 102, to engage a user with the rehabilitation system. The pedal 102 is configured for interacting with a patient to be rehabilitated and may be configured for use with lower body extremities such as the feet or legs, or upper body extremities such as the hands or arms, or any other suitable body parts. The pedal 102 is positioned on a spindle 103 that is supported on a pedal arm assembly 104. The pedal 102 can be pivotably mounted on the spindle 103. The pedal arm assembly 104 is connected to the axle 105 of the base 110, which supports and, at times, drives the axle 105. As will be described in greater detail below, the pedal arm assembly 104 may have a center of gravity positioned adjacent where the pedal arm assembly 104 is coupled to the axle 105 to permit the pedal arm assembly 104 to be coupleable to either of a first end 105a of the axle 105 or an opposite second end 105b of the axle 105. A controller 112 is electrically connected to the pedal arm assembly 104 to provide a control signal to control operation of the pedal arm assembly 104.

The pedal arm assembly 104 can be coupled to the axle 105 of the rehabilitation or exercise machine with the axle being radially offset from the axis of the spindle 103 to define a range of radial travel of the pedal 102 relative to the axle 105. As shown in FIG. 1, the pedal 102 can be moved from a first position (solid line) to a second position as illustrated by pedal 102′ (broken line). The spindle 103 is moved by the pedal arm assembly relative to the fixed axle 105 from the first position (solid line, 103) and a second position (broken line, 103′). The pedal arm assembly 104 is electrically actuatable by a control signal 117 from the controller 112. The pedal arm assembly 104 adjusts a radial position of the pedal 102, e.g., from the solid line position to the broken line position or vice versa, or to any position in between, relative to the axle. In an embodiment with two pedals, one for the left foot and one for the right, each pedal can be individually controlled by the controller 112. The pedal 102 (solid line) is positioned radially outwardly from the pedal 102′ (broken line). The pedal 102 will have a larger travel path than the pedal 102′ as they rotate around the axle 105. The base 110 includes an electric motor 114 for providing a driving force or resistance to the pedal 102 and for providing a simulated flywheel 115.

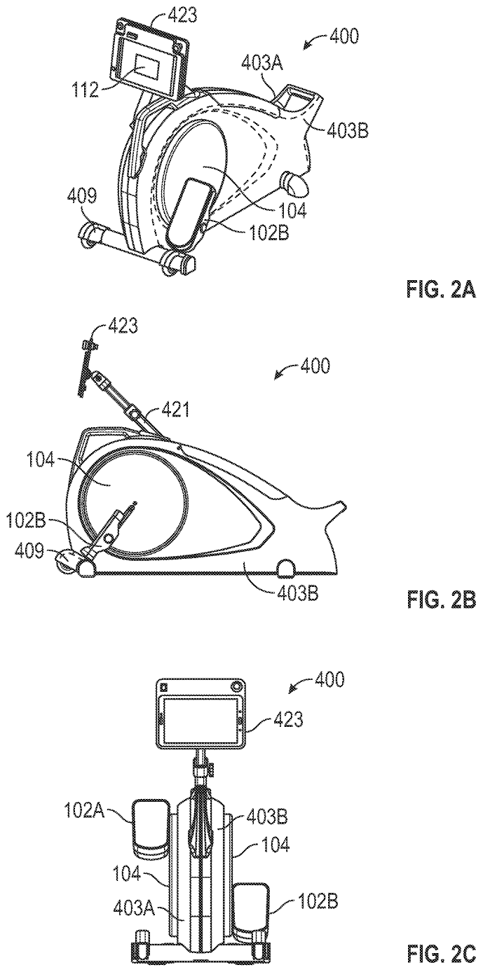

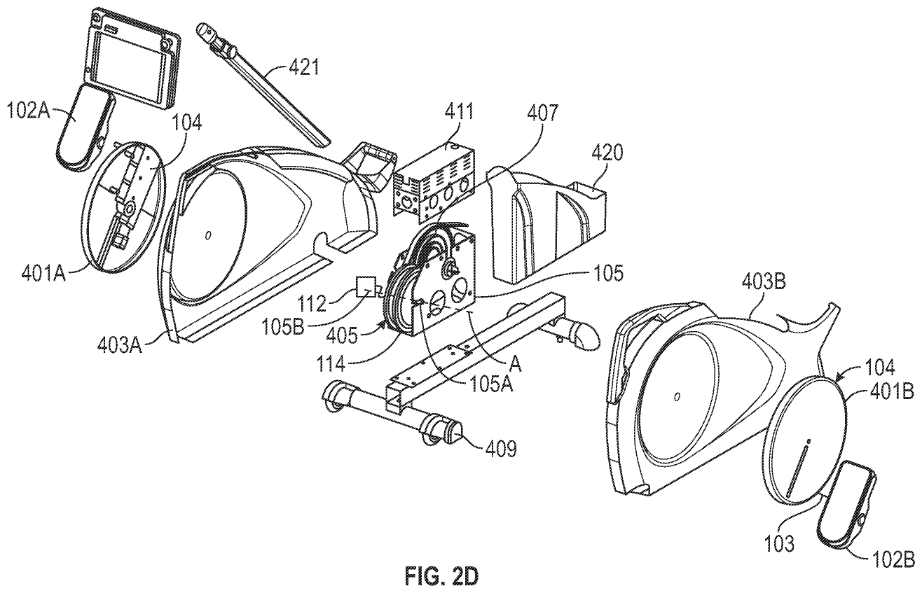

FIGS. 2A-2D depict the exercise or rehabilitation electromechanical device 100 that includes the pedal system 101. The electromechanical device 100 includes a left pedal 102A that couples to a left radially-adjustable coupling assembly 104 via a spindle 103 through a shroud 401. The radially-adjustable coupling 124 and shroud 401 can be disposed in a circular opening of a left outer cover 403 and the pedal arm assembly 104 can be secured to a drive sub-assembly 405. The drive sub-assembly 405 may include the electric motor 114 that is operably coupled to the controller 112. The drive sub-assembly 405 may include one or more braking mechanisms, such as disc brakes, which enable instantaneously locking the electric motor 114 or stopping the electric motor 114 over a period of time. The electric motor 114 may be any suitable electric motor (e.g., a crystallite electric motor). The electric motor 114 may drive the axle 105 directly. In the illustrated example, the motor 114 connects to a central pulley 407 that is fixed to the axle 105. The central pulley 407 can be connected to the drive axle of the electric motor 114 by a belt or chain or can be directly connected to the electric motor 114. The central pulley 407 can be a lightweight polymer wheel having apertures therein to save weight. The central pulley 407 is lightweight such that it does not provide any significant inertial energy that resists movement of the pedals 102 in use. The drive sub-assembly 405 can be secured to a frame sub-assembly 409, which includes a main support spine and legs extending outwardly therefrom. One set of legs may include wheels to move the system. A top support sub-assembly 411 may be secured on top of the drive sub-assembly 405 to essentially enclose the electric motor 114 and the central pulley 407. A right pedal 102B couples to a right radially-adjustable coupling 401B via a right pedal arm assembly 104 disposed within a cavity of the right radially-adjustable coupling 401B. The right pedal 102B is supported in the same manner as the left pedal 102A, but on the other side and 180 degrees out of phase with the left pedal 102A. However, it is contemplated and possible that the left pedal 102A is in phase with the right pedal 102B, or is out of phase by any degree with the right pedal 102B. An internal volume may be defined when the left outer cover 403A and the right outer cover 403B are secured together around the frame sub-assembly 409. The left outer cover 403A and the right outer cover 403B may also make up the frame of the device 100 when secured together. The drive sub-assembly 405, top support sub-assembly 411, and pedal arm assemblies 104 may be disposed within the internal volume upon assembly. A storage compartment 420 may be secured to the frame sub-assembly 409 to enclose the drive sub-assembly 405 and top support sub-assembly 411.

Further, a computing device arm assembly 421 may be secured to the frame and a computing device mount assembly 422 may be secured to an end of the computing device arm assembly 421. A computing device 423 (e.g., controller 112) may be attached or detached from the computing device mount assembly 421 as desired during operation of the device 100.

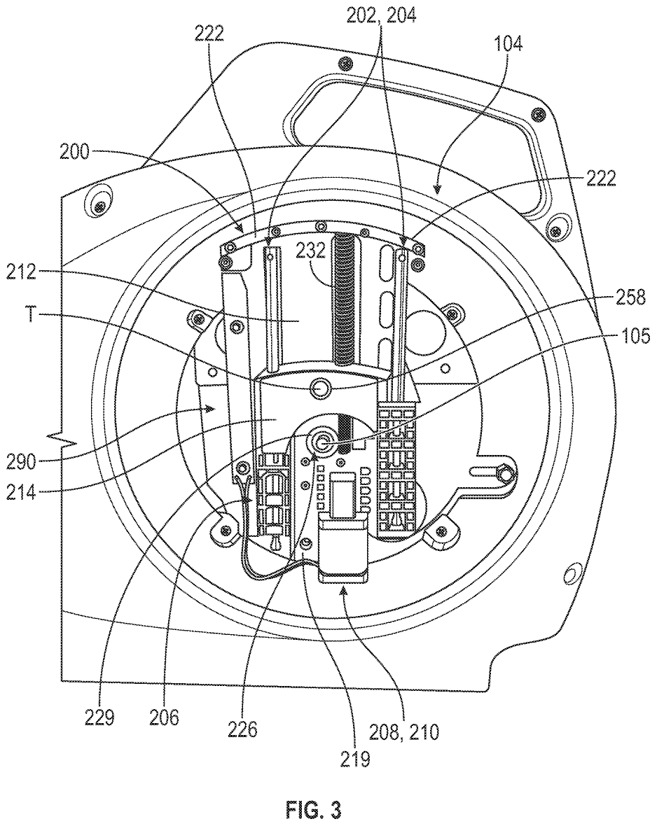

FIG. 3 depicts one of the pedal arm assemblies 104 mounted to the drive sub-assembly 405. The depicted pedal arm assembly 104 is fixedly coupled to the fixed spindle 105 to rotate with the spindle 105 when the motor 114 is actuated. While a single pedal arm assembly 104 is depicted mounted on one side of the drive sub-assembly 405, a pair of pedal arm assemblies 104 are secured to opposing sides of the drive sub-assembly 405 by the spindle 105, or rotational axle, to rotate with the drive sub-assembly 405. Each pedal arm assembly 104 may be identical, permitting a single manufacturing assembly line to be used in the manufacture of both pedal arm assemblies 104. The pedal arm assemblies 104 may be asymmetrical about an axis A extending along a length of the pedal arm assembly 104 such that the rehabilitation device 100 is asymmetrical about a length of the rehabilitation device 100 when the pedal arm assemblies 104 are mounted to the drive sub-assembly 405.

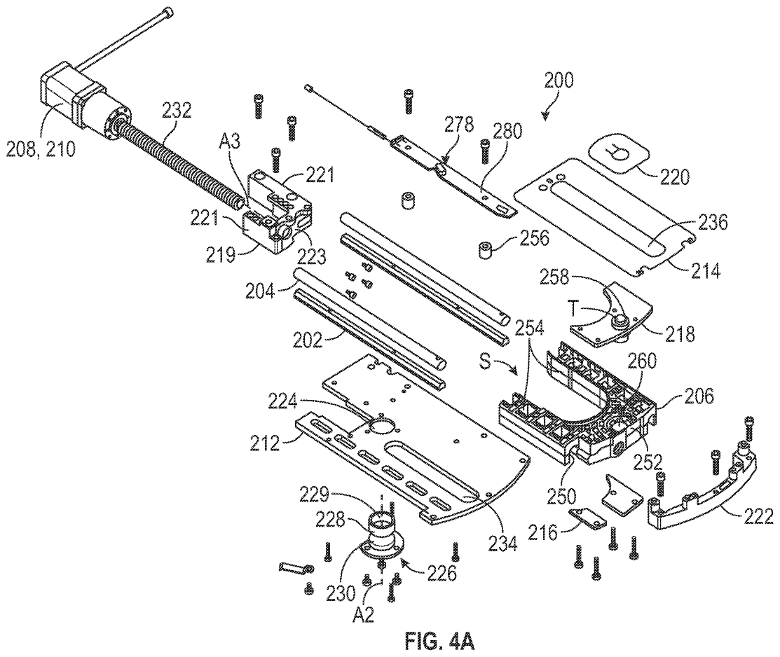

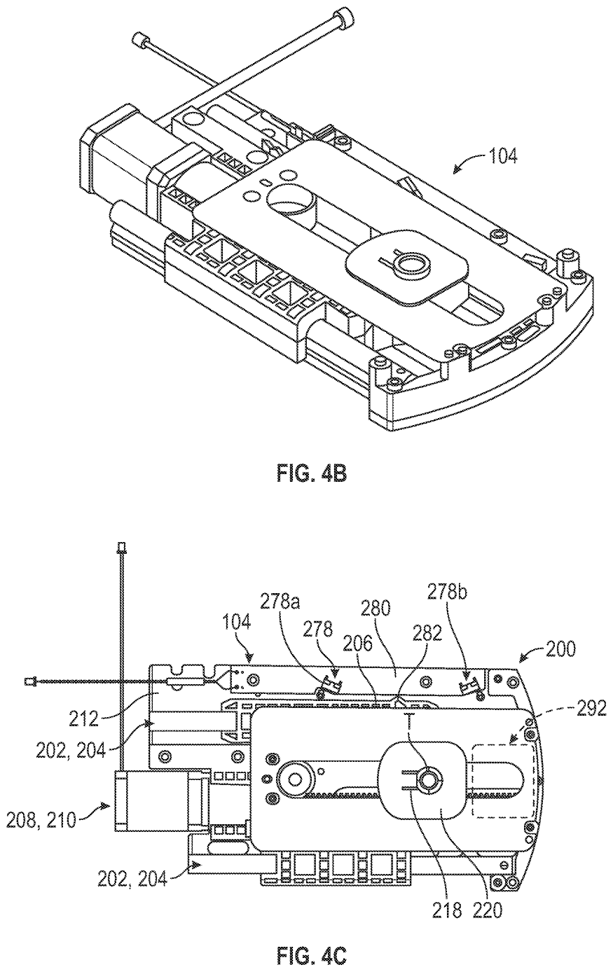

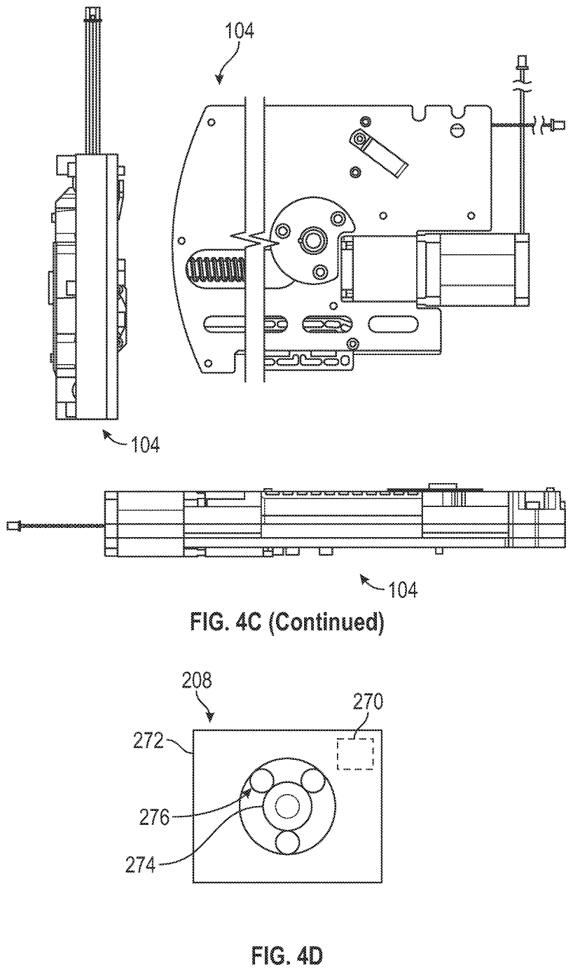

Referring to FIGS. 3, 4A, and 4B, each pedal arm assembly 104 may include an enclosure 200, a pair of rails 202, a pair of rods 204, a carriage 206 linearly and slidably movable along the pair of rails 202 and the pair of rods 204, a motor 208, and a controller 210 for controlling the motor 208. The enclosure 200 may at least partially enclose the other components of the pedal arm assembly 104 and couple those components together, including at least the motor 208, the carriage 206, the pair of rails 202, and the pair of rods 204.

The enclosure 200 may include a base 212, a pinch barrier 214, a pair of plates 216, a carriage weldment 218, a pinch protection disc 220, a distal support 222, and a motor mount 219. The motor mount 219 may couple the motor 208 to the base 212, and include a center portion 223 extending between a pair of arms 221 that extend in parallel. The center portion 223 may define an aperture configured to receive a leadscrew. The pair of arms 221 may include a first arm positioned closer to the first rod 204 than a second arm, the second arm being positioned closer to the second rod than the first arm, and the first arm may have a length that is greater than a length of the second arm.

The base 212 may be a flat, plate structure defining a first aperture 224 for receiving a hub 226 that extends into the first aperture and is fixedly between the base 212 and the rotational axle to couple, or mount, the base 212 to the rotational axle to rotate with the drive sub-assembly. The hub 226 may include a cylindrical body 228 circumscribing an axis A2 and defining a recessed portion 230 sized to position a leadscrew 232 therein, as will be described in greater detail herein. An axis A3 extending along a length of the leadscrew 232 may intersect the center of gravity of the pedal assembly 104, where the center of gravity may be positioned within the hub 226. The axis A3 may intersect the central aperture 229 of the hub 226. Various components of the pedal assembly 104 may be sized asymmetrically to position the center of gravity within the hub 226. For example, the pair of rods 204 may include a first rod and a second rod, the first rod having a length that is greater than a length of the second rod, and the hub 226 may be positioned closer to the first rod than the second rod.

The base 212 may define an elongated slot 234 that permits the leadscrew 232 to be visible and accessible through the base 212 when the pedal arm assembly 104 is assembled. The pinch barrier 214 may similarly be a flat, plate structure defining an elongated slot 236. The elongated slot 236 defines the linear travel of the spindle 103 (and, hence, the pedal 102) relative to the fixed axle 105. The pinch barrier 214 may be disposed opposite the base 212 with the carriage 206 positioned between the pinch barrier 214 and the base 212. The distal support 222 may be positioned at an end of each of the base 212 and the pinch barrier 214, and be fixed to each of the pinch barrier 214 and the base 212 to couple the pinch barrier 214 and the base 212 at the end. The motor adapter 240 may be positioned to be in contact with the motor 208 and define a throughbore 242 for the leadscrew 232 to extend therethrough. The motor mount 219, or motor adapter, may be spaced apart from the distal support 222 to be positioned at another end of each of the pinch barrier 214 and the base 212, where the pinch barrier 214 and the base 212 are fixed to the motor mount 219 to be fixed together at the other end.

The carriage weldment 218 may be attached to the carriage 206 and include a threading T for coupling to a pedal. The threading T may be formed in an extrusion that extends through the elongated slot 234 in the pinch barrier 214. The pair of plates 216 may be positioned opposite the carriage weldment 218 with the carriage 206 positioned therebetween to have fasteners extend through the pair of plates 216 and carriage weldment 218 to couple both the pair of plates 216 and the carriage weldment 218 to the carriage 206.

Referring still to FIGS. 3, 4A, and 4B, the pair of rails 202 may be mounted to the base 212 in parallel and extend along a length of the base 212. The pair of rods 204 may be coupled to the base 212 with the pair of rails 202 therebetween, and be mounted in parallel adjacent to each other, respectively. The pair of rods 204 may be rounded and extend with the rails 202 from the end of the base 212 to the other end of the base 212 to be in contact with, or adjacent to, the distal support 222. In embodiments, the rods 204 and/or rails 202 may be attached to the distal support 222. The rods 204 and the rails 202 may extend from the motor 208 to the distal support 222 to permit the carriage 206 to move between the motor 208 and the distal support 222.

The carriage 206 defines a pair of channels 250 that the pair of rails 202 and the pair of rods 204 are positioned within to guide the carriage 206 along the pair of rails 202 and the pair of rods 204. The carriage 206 may include an arch 252 and a pair of columns 254 extending from the arch 252 that define the pair of channels 250, and the pair of columns 254 are integrally and monolithically connected by the arch 252. The pair of columns 254 may include a first column having a length that is greater than a length of a second column. The first column may be positioned adjacent to the first rod, and the second column may be positioned adjacent to the second rod.

The carriage 206 is movable between a first position 290 (FIG. 3) and a second position 292 (shown in phantom in FIG. 4C) spaced apart from the first position 290, the pair of columns 254 and the arch 252 of the carriage 206 extend at least partially around a space S, and when the carriage 206 is in the first position 290, the motor 208 is positioned within the space S. The carriage 206 may further include a throughbore 256 extending through the arch 252 that receives the leadscrew 232 and a threaded nut 258 at least partially positioned in the throughbore 256 and fixedly coupled to the arch 252 to threadingly engage the leadscrew 232 and move the carriage 206 along the rails 202 and rods 204 toward or away from the motor 208 when the leadscrew 232 rotates. The carriage 206 may define an aperture 260 through the arch 252 that is configured to couple to a spindle that supports a pedal. The carriage weldment 218 may be aligned with the aperture 260 of the carriage 206 with the extrusion partially positioned within the aperture 260 to permit a pedal to be threadingly attached to the threads T of the extrusion, thereby coupling the pedal to the carriage 206. The pinch protection disc 220 is attached to the extrusion by, for example, a force-fit engagement that moves with the carriage 206 and contacts the pinch barrier 214 to assist in preventing rotation of the carriage 206 in the enclosure 200.

The motor 208 is coupled to the base 212 and operatively coupled to the leadscrew 232 threadingly engaged with the carriage 206 to linearly move the carriage 206 along the rails 202 and rods 204 relative to the base 212 and perpendicular to the rotational axle when the motor 208 is actuated. The leadscrew 232 can be threaded its entire length. The leadscrew 232 can be rotated in either a clockwise direction or a counterclockwise direction by the motor 208. The leadscrew 232 may be partially positioned within the recessed portion 230 of the hub 226 to spaced apart from the hub 226.

Referring to FIG. 4D, a cross-sectional view of the motor 208 is depicted, where the motor 208 may include a controller 270, a housing 272, a rotating spindle 274, and a planetary gear set 276 positioned within the housing 272 that transfers rotation from the spindle 274 to the leadscrew 232 (FIG. 4A). The controller 270 may control the motor 208 to rotate the rotating spindle 274 and to position the carriage 206 a selected radial distance from the rotational axle 105.

Referring again to FIGS. 3-4C, the pedal arm assembly 104 may further include at least one position sensor 278, wherein the carriage 206 has a path of travel along the pair of rods 204 and is movable between the first position 290 at a first end of the path of travel and the second position 292 at a second end of the path of travel. The position sensor 278 may be configured to detect when the carriage 206 is in the first position 290 or the second position 292. The at least one position sensor 278 may include a first position sensor 278a configured to detect when the carriage 206 is in the first position 290, and a second position sensor 278b configured to detect when the carriage 206 is in the second position 292. Each of the first position sensor 278a and the second position sensor 278b may be limit switches that detect the position of the carriage 206 when contacted by the carriage 206. The limit switches may be positioned on an elongated plate 280 coupled to the base 212 to be contactable by the carriage 206. The carriage 206 may include a notch 282 that extends from one of the pair of columns 254 to contact the first position sensor 278a in the first position 290 and the second position sensor 278b in the second position 292.

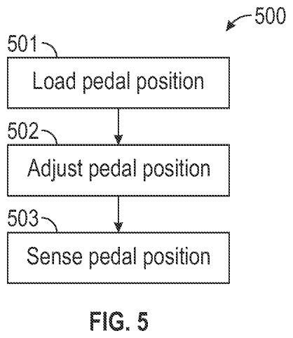

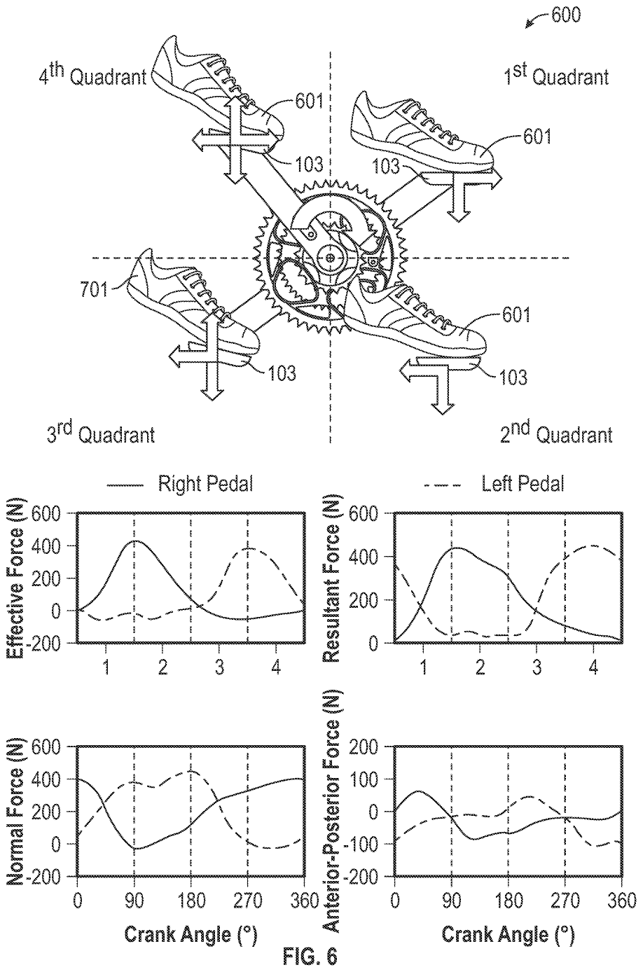

FIG. 5 is a flowchart of a method 500 for controlling the pedal position. At 501, a pedal position is loaded into the controller 112 or memory 113. The pedal position can be entered via a user interface through an I/O on the base 110. The user interface can present a treatment plan (e.g., for rehabilitation or exercise) for a user according to certain embodiments of this disclosure. The user interface can be at the base or at a remote device in communication with the base. The treatment plan can be set by a user (e.g., a physician, nurse, physical therapist, patient, or any other suitable user). The pedal position can be part of an individualized treatment plan taking into account the condition of the user (e.g., recovery after a surgery, knee surgery, joint replacement, a muscle conditions or any other suitable condition).

At 502, the radial position of a pedal, such as, for example, the left pedal 102A, relative to the axle 105 is electrically adjusted in response to a control signal output by the controller 112 to control the electric motor 208 to position the carriage 206, and hence the pedal 102, through the spindle 103. The radial position of the pedal may be adjusted by actuating the motor 208 of one of the pedal assemblies 104 to rotate the respective leadscrew threadingly engaged with the carriage to move the carriage relative to the base coupled to the drive sub-assembly, thereby adjusting the radial position of the carriage relative to the spindle 105. As the carriage is coupled to the drive sub-assembly by the rotational axle 105, actuation of the motor adjusts the radial position of the carriage relative to the rotational axle 105. Further, as the pedal is attached to the carriage, the radial position of the pedal is adjusted with the adjustment of the carriage.

The carriage of each pedal assembly rotates with the drive sub-assembly such that adjusting the radial position of each carriage and pedal produces an elliptical path relative to the rotational axle during a revolution of the drive sub-assembly. The radial position of the pedal can be adjusted in response to the control signal during a user pedaling the pedal.

As mentioned previously, the pedals may be 180° out of phase with one another, such that the radial position of the other pedal, such as the right pedal 102B, relative to the axle 105 is electrically adjusted by actuating the motor of the respective pedal assembly to rotate the respective leadscrew threadingly engaged with the carriage to move the carriage opposite the carriage attached to the left pedal 102A and relative to the base coupled to the drive sub-assembly, thereby moving the left pedal 102A and the right pedal 102B in opposite directions. In other words, the carriages of each pedal assembly may both move toward the rotational axle 105 or away from the rotational axle 105. The distances that the left pedal 102A and the right pedal 102B are adjusted relative to the axle 105 may be the same. However, it is contemplated and possible that the distances are different.

The rotational motion of the user engaged with the pedal may be controlled, where the controller can control the position of the pedal 103 in real time according to the treatment plan. The position of a right pedal can be different than that of the left pedal. The pedal can also change position during the use.

At 503, the rotational position of the pedal is sensed, and may be sensed by a rotational position sensor, such as a Hall-effect sensor. The rotational position of the pedal can provide information regarding the use, e.g., to control radial position of the pedal, the rotational motion (e.g., speed, velocity, acceleration, etc.) and the like. In response to the sensing of the rotational position of the carriage, the controller actuates the motor to move the carriage relative to the base. This process is applicable to each of the pedal assemblies attached to the left pedal 102A and the right pedal 102B.

The actuation of the motors to adjust the radial position of the pedals adjusts the radial position of the carriage of each of the pedal assemblies 104 relative to the rotational axle 105. In embodiments, the pedal assemblies 104 may be coupled to a single rotational axle 105. However, it is contemplated and possible that the device 100 includes a pair of rotational axles 105 coupled to the motor 112 with the pedal assemblies 104 being attached to separate rotational axles 105.

FIG. 6 is a schematic view 600 of a pedal 103 and resultant force vectors. The pedal 103 will experience greater applied force from the foot 601 (represented by the shoe) in the first quadrant and the second quadrant (i.e., when driving the pedal down). There will be the less applied force in the third quadrant and fourth quadrants. When pedaling a bicycle with forward motion and inertial energy, or a stationary bike with a heavy flywheel, e.g., greater than twenty pounds, the user experiences inertial force that affects the feel experienced by the user. In an example embodiment, the drive components (e.g., the electric motor, the pulley, the pedal connector assembly, and the pedals) all have a mass of less than 10 kilograms. The inertial force can be felt when there is a reduced applied force, e.g., when both pedals are not applying a force. A heavily weighted flywheel will continue the force felt by the user (e.g., greater than 15 kg, greater than 20 kg, or more). However, an example embodiment of the present disclosure does not have a heavy flywheel. In this case, the electric motor must be controlled to simulate a flywheel and the inertia of the flywheel, which can be felt by a user, such that the electric motor controls a resistance to travel of the pedals. If the electric motor did not provide increased force to the pedal, then the pedal would slow a greater amount. If the electric motor did not provide a resistance to the force applied by the user to the pedal, the user could not apply a sufficient force to the pedal. Thus, the control system simulates the flywheel by controlling the electric motor to drive the pulley when the one or more pedals are not rotating within a desired range. Controlling the electric motor 114 to simulate a flywheel can assist in keeping the user compliant with the treatment plan on the rehabilitation device 100.

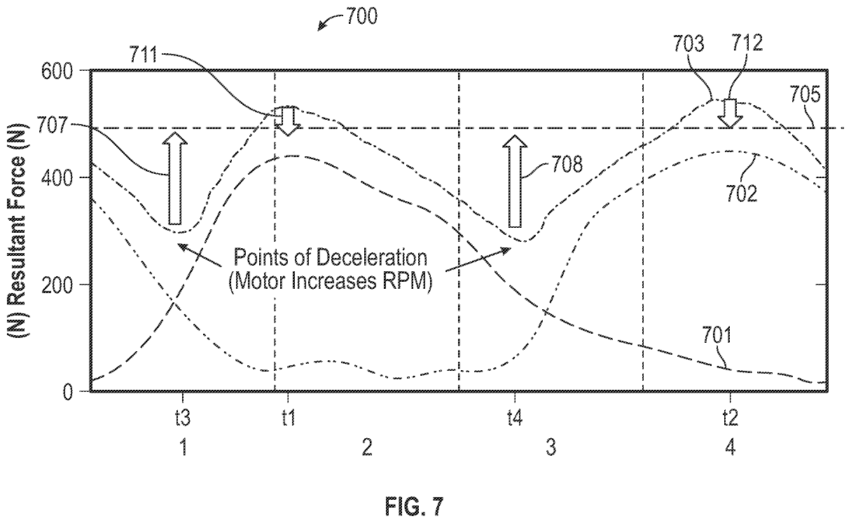

FIG. 7 shows a graph 700 of pedaling forces from pedaling and a simulated flywheel from the electric motor 114. The applied force at the right pedal 701 peaks at time t1 essentially between quadrant 1 and 2. The quadrants are defined relative to the right pedal. The applied force at the left pedal 702 peaks at time t2 in quadrant 4. The sum of the applied forces of both the right pedal and the left pedal is shown at 703. At 705, there is shown the desired steady force that a user experiences with a flywheel. The desired level of force can be changed according to the rehabilitation regimen prescribed to the user, which can be stored in memory and used by a controller. In the illustrated example of FIG. 7, the force is set at about 500N. It is desired, in some embodiments of the present disclosure, to simulate a flywheel by driving the electric motor 114 when the sum of forces 703 fall below the desired level of force 705. At time t3, the electric motor 114 must drive the pedals to accelerate the pedals so that the force at the pedals is at the desired level of force 705. The same occurs at time t4. The force applied by the electric motor 114 is schematically shown at 707, 708. At times t3, t4, the pedals are not receiving enough force from the user and the rotational speed will drop. The electric motor 114 applies an acceleration to keep the force essentially the same, i.e., by Newton's second law, F=m*a. In the present device 100, the mass is quite low so that the system is portable. Accordingly, the change in acceleration will have an effect on the force perceived by the user at the pedals as the mass of the drive components in the present rehabilitation system is low. At times t1 and t2, the force at the pedals is at its highest and is above the desired level of force 705. Here, the electric motor 114 will drop the force at the pedals. While there will be some variation from the desired level of force due to the forces applied to the pedals at different quadrants and positions of the pedals in the travel path, the force can be held in a range around the set value at 705.

The foregoing description of the embodiments describes some embodiments with regard to exercise system or a rehabilitation system or both. These phrases are used for convenience of description. The phrases exercise system or rehabilitation system as used herein include any device that is driven by or causes motion of a person or animal, typically to provide travel of body parts. The exercise system can include devices that cause travel of an extremity or appendage, i.e., a leg, an arm, a hand, or a foot. Other embodiments of exercise systems or rehabilitation systems can be designed for range of motion of joints.

The foregoing description describes a pedal, which is engaged by a user's foot to impart force to the pedal and rotate the pedals along a travel path defined by the position of the pedal relative to the rotational axis of the device. The description relating to a pedal herein can also be applied to handgrips such that a user can grip the handgrips and the device can operate in the same manner as described herein. In an example embodiment, the term pedal can include a handgrip.

The rehabilitation and exercise device, as described herein, may take the form as depicted of a traditional exercise/rehabilitation device which is non-portable and remains in a fixed location, such as a rehabilitation clinic or medical practice. In another example embodiment, the rehabilitation and exercise device may be configured to be a smaller, lighter and more portable unit so that it is able to be easily transported to different locations at which rehabilitation or treatment is to be provided, such as a plurality of patients' homes, alternative care facilities or the like.

Consistent with the above disclosure, the examples of systems and method enumerated in the following clauses are specifically contemplated and are intended as a non-limiting set of examples.

The structures connected to the pedals have a low mass and, hence, a low inertial energy potential. The motor, e.g., through a wheel connected to the axle, can provide the resistive force at the pedals and the inertial force once the pedals are turning.

The foregoing description of the embodiments describes some embodiments with regard to an exercise system or a rehabilitation system or both. These phrases are used for convenience of description. The phrases exercise system or rehabilitation system as used herein include any device that is driven by or causes motion of a person or animal, typically to provide travel of body parts. The exercise system can include devices that cause travel of an appendage, i.e., a leg, an arm, a hand, or a foot. Other exercise systems or rehabilitation systems can be designed for a range of motion of joints.

The foregoing description describes a pedal, which is engaged by a user's foot to impart force to the pedal and rotate the pedals along a travel path defined by the position of the pedal relative to the rotational axis of the device. The description relating to a pedal herein can also be applied to handgrips such that a user can grip the handgrips and the device can operate in the same manner as described herein. In an example embodiment, the term pedal can include a handgrip.

The rehabilitation and exercise device, as described herein, may take the form as depicted of a traditional exercise/rehabilitation device which is more or less non-portable and remains in a fixed location, such as a rehabilitation clinic or medical practice. In another example embodiment, the rehabilitation and exercise device may be configured to be a smaller, lighter and more portable unit so that it is able to be easily transported to different locations at which rehabilitation or treatment is to be provided, such as a plurality of patient's homes, alternative care facilities or the like. In other embodiments, this equipment can be used in other unrelated applications, such as other types of pedal-powered vehicles (e.g., bicycles, etc.), a hand-powered winch, etc.

The foregoing description of the embodiments has been provided for purposes of illustration and description. It is not intended to be exhaustive or to limit the disclosure. Individual elements, assemblies/subassemblies, or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure. The benefits, advantages, solutions to problems, and any feature(s) that can cause any benefit, advantage, or solution to occur or become more pronounced are not to be construed as a critical, required, sacrosanct or an essential feature of any or all the claims.

### CLAUSES

1. An exercise or rehabilitation electromechanical device, comprising:
   a drive sub-assembly; and
   a pair of pedal assemblies secured to opposing sides of the drive sub-assembly by a rotational axle to rotate with the drive sub-assembly, each pedal assembly comprising:
      a base mounted to the rotational axle to rotate with the drive sub-assembly;
      a pair of rails mounted to the base in parallel;
      a pair of rods coupled to the base in parallel adjacent to but spaced apart from the rails, respectively;
      a carriage linearly and slidably movable along the pair of rails and the pair of rods, and the carriage has an aperture to couple to a spindle that supports a respective pedal;
      a motor coupled to the base and operatively coupled to a leadscrew threadingly engaged with the carriage to linearly move the carriage along the rails and rods relative to the base and perpendicular to the rotational axle when the motor is actuated; and
   a controller for controlling the motor to position the carriage a selected radial distance from the rotational axle.
2. The exercise or rehabilitation electromechanical device of any clause herein, wherein the motor comprises:
   a housing;
   a rotating spindle; and
   a planetary gear set positioned within the housing, and the planetary gear set transfers rotation from the spindle to the leadscrew.
3. The exercise or rehabilitation electromechanical device of any clause herein, wherein the carriage defines a pair of channels within which the pair of rails and the pair of rods are positioned in order to guide the carriage along the pair of rails and the pair of rods.
4. The exercise or rehabilitation electromechanical device of any clause herein, wherein the carriage comprises an arch and a pair of columns extending from the arch such that the arch and the pair of columns define the pair of channels, and the pair of columns is integrally and monolithically connected by the arch.
5. The exercise or rehabilitation electromechanical device of any clause herein, wherein the carriage is movable between a first position and a second position spaced apart from the first position, the pair of columns and the arch of the carriage extend at least partially around a space, and the motor is positioned within the space when the carriage is in the first position.
6. The exercise or rehabilitation electromechanical device of any clause herein, further comprising a position sensor, wherein the carriage has a path of travel along the pair of rods and is movable between a first position at a first end of the path of travel and a second position at a second end of the path of travel, and the position sensor is configured to detect when the carriage is in the first position or the second position.
7. The exercise or rehabilitation electromechanical device of any clause herein, further comprising a second position sensor wherein the position sensor and the second position sensor are each limit switches, and the carriage comprises a notch that contacts the position sensor in the first position, and the notch contacts the second position sensor in the second position.
8. The exercise or rehabilitation electromechanical device of any clause herein, wherein the pair of rails or both the pair of rails and the pair of rods are formed with the base as an integral one-piece, monolithic structure.
9. The exercise or rehabilitation electromechanical device of any clause herein, wherein the carriage comprises a throughbore that receives the leadscrew and a threaded nut at least partially positioned in the throughbore, and the threaded nut threadingly engages the leadscrew.
10. The exercise or rehabilitation electromechanical device of any clause herein, wherein actuation of the motor during a revolution of the drive sub-assembly adjusts a radial position of the carriage relative to the rotational axle to produce a pedal path about the rotational axle.
11. The exercise or rehabilitation electromechanical device of any clause herein, further comprising a hub coupling the base to the rotational axle, wherein the hub defines a depression shaped to be complementary to the shape of the leadscrew, and the leadscrew is at least partially positioned within the depression of the hub.
12. The exercise or rehabilitation electromechanical device of any clause herein, further comprising:
   a pinch barrier mounted to the motor mount and the distal support to cover the leadscrew and the carriage from external exposure; and
      a pinch protection plate on an exterior of the pinch barrier and slidably movable with the carriage to cover an aperture in the pinch barrier.
13. A pedal assembly for equipment for electromechanical exercise or rehabilitation of a user, the pedal assembly comprising:
   a base configured to be mounted to and rotate with the rotational axle of the equipment;
      a pair of rails mounted to the base in parallel;
      a pair of rods coupled to the base in parallel adjacent to but spaced apart from the pair of rails, respectively;
      a carriage linearly and slidably movable along the pair of rails and the pair of rods, the carriage has an aperture to couple to a spindle that supports a pedal;
      a motor coupled to the base for driving a leadscrew to threadingly engage and linearly move the carriage along the rails and rods relative to the base and perpendicular to the rotational axle; and
      a controller for controlling the motor to position the pedal a selected radial distance from the rotational axle.
14. The pedal assembly of any clause herein, wherein the carriage defines a pair of channels within which the pair of rails and the pair of rods are positioned in order to guide the carriage along the pair of rails and the pair of rods.
15. The pedal assembly of any clause herein, wherein the carriage comprises an arch and a pair of columns extending from the arch such that the arch and the pair of columns define the pair of channels, and the pair of columns is integrally and monolithically connected by the arch.
16. The pedal assembly of any clause herein, wherein the carriage is movable between a first position and a second position spaced apart from the first position, the pair of columns and the arch of the carriage extend at least partially around a space, and the motor is positioned within the space when the carriage is in the first position.
17. A method for electromechanical exercise or rehabilitation for a user, comprising:
   actuating a first motor of a first pedal assembly to rotate a first leadscrew threadingly engaged with a first carriage to move the first carriage relative to a first base coupled to a drive sub-assembly; and
   actuating a second motor of a second pedal assembly to rotate a second leadscrew threadingly engaged with a second carriage to move the second carriage opposite the first carriage and relative to a second base coupled to the drive sub-assembly.
18. The method of any clause herein, further comprising:
   actuating the first motor to move the first carriage relative to the first base in response to sensing a rotational position of the first carriage; and
   actuating the second motor to move the second carriage relative to the second base in response to sensing a rotational position of the second carriage.
19. The method of any clause herein, wherein:
   the first carriage is coupled to the drive sub-assembly by a first rotational axle, and actuation of the first motor adjusts a radial position of the first carriage relative to the rotational axle, and
   the second carriage is coupled to the drive sub-assembly by a second rotational axle, and actuation of the second motor adjusts a radial position of the second carriage relative to the second rotational axle.
20. The method of any clause herein, wherein the first carriage and the second carriage rotate with the drive sub-assembly, and adjusting the radial position of the first carriage and the second carriage comprises adjusting the radial position of each carriage to produce a pedal path relative to the rotational axle during a revolution of the drive sub-assembly.
21. A method for electromechanical exercise or rehabilitation for a user, comprising:
   actuating a motor of a pedal assembly to rotate a leadscrew threadingly engaged with a carriage to move the carriage along a pair of rails and a pair of rods relative to a base coupled to a drive sub-assembly as the base rotates with the drive sub-assembly.
22. The method of any clause herein, further comprising:
   actuating the motor to move the carriage relative to the base in response to sensing a rotational position of the carriage.
23. The method of any clause herein, wherein:
   the carriage is coupled to the drive sub-assembly by a rotational axle, and actuation of the motor adjusts a radial position of the carriage relative to the rotational axle.
24. The method of any clause herein, wherein the carriage rotates with the drive sub-assembly, and adjusting the radial position of the carriage comprises adjusting the radial position of the carriage to produce an elliptical path relative to the rotational axle during a revolution of the drive sub-assembly.
25. An exercise or rehabilitation electromechanical device, comprising:
   a drive sub-assembly comprising an electric motor and a rotational axle that is rotatable by the electric motor around an axis, and the rotational axle comprises a first end and an opposite second end spaced apart from the first end along the axis; and
   a pedal assembly coupleable to either of the first end and the second end of the rotational axle, the pedal assembly comprising:
a base coupleable to the rotational axle by a hub to rotate with the drive sub-assembly;
   at least one rod coupled to the base;
   a carriage linearly and slidably movable along the at least one rod, and the carriage has an aperture to couple to a spindle that supports a pedal;
   a motor coupled to the base and operatively coupled to a leadscrew threadingly engaged with the carriage to linearly move the carriage along the at least one rod relative to the base and perpendicular to the rotational axle when the motor is actuated; and
   a controller for controlling the motor to position the carriage a selected radial distance from the rotational axle.
26. The exercise or rehabilitation electromechanical device of any clause herein, further comprising an axis extending along a length of the leadscrew that intersects a center of gravity of the pedal assembly, the axis intersects a central aperture of the hub, wherein the at least one rod comprises a first rod and a second rod extending in parallel with one another, and the hub is positioned closer to the first rod than the second rod.
27. The exercise or rehabilitation electromechanical device of any clause herein, wherein the first rod has a length that is greater than a length of the second rod.
28. The exercise or rehabilitation electromechanical device of any clause herein, wherein the carriage comprises an arch and a pair of columns extending from the arch in parallel, and a first column of the pair of columns has a length that is greater than a length of a second column of the pair of columns.
29. The exercise or rehabilitation electromechanical device of any clause herein, wherein the carriage defines a pair of channels in the pair of columns within which the pair of rods are positioned in order to guide the carriage along the pair of rods.
30. The exercise or rehabilitation electromechanical device of any clause herein, wherein the carriage is movable between a first position and a second position spaced apart from the first position, the pair of columns and the arch of the carriage extend at least partially around a space, and the motor is positioned within the space when the carriage is in the first position.
31. The exercise or rehabilitation electromechanical device of any clause herein, wherein the hub defines a depression, and the leadscrew is at least partially positioned within the depression of the hub.
32. The exercise or rehabilitation electromechanical device of any clause herein, further comprising a position sensor, wherein the carriage has a path of travel along the pair of rods and is movable between a first position at a first end of the path of travel and a second position at a second end of the path of travel, and the position sensor is configured to detect when the carriage is in the first position or the second position.
33. The exercise or rehabilitation electromechanical device of any clause herein, further comprising a second position sensor wherein the position sensor and the second position sensor are each limit switches, and the carriage comprises a notch that contacts the position sensor in the first position, and the notch contacts the second position sensor in the second position.
34. An exercise or rehabilitation electromechanical device, comprising:
   a drive sub-assembly comprising an electric motor and a rotational axle that is rotatable by the electric motor; and
   a pair of pedal assemblies each comprising:
      a base;
      a pair of rods comprising a first rod and a second rod each mounted to the base in parallel;
         a carriage linearly and slidably movable along the pair of rods, and the carriage has an aperture to couple to a spindle that supports a respective pedal;
      a hub coupling the base to the rotational axle; and
      a motor coupled to the base and operatively coupled to a leadscrew threadingly engaged with the carriage to linearly move the carriage along the rods relative to the base and perpendicular to the rotational axle when the motor is actuated,
      wherein the hub is positioned between the leadscrew and the first rod, the leadscrew is positioned between the hub and the second rod, and the first rod has a length that is greater than a length of the second rod.
35. The exercise or rehabilitation electromechanical device of any clause herein, wherein the hub defines a depression, and the leadscrew is at least partially positioned within the depression of the hub.
36. The exercise or rehabilitation electromechanical device of any clause herein, further comprising an axis extending along a length of the leadscrew that intersects a center of gravity of the pedal assembly, the axis intersects a central aperture of the hub.
37. The exercise or rehabilitation electromechanical device of any clause herein, wherein the first rod has a length that is greater than a length of the second rod.
38. The exercise or rehabilitation electromechanical device of any clause herein, wherein the carriage comprises an arch and a pair of columns extending from the arch in parallel, and a first column of the pair of columns has a length that is greater than a length of a second column of the pair of columns.
39. The exercise or rehabilitation electromechanical device of any clause herein, wherein the carriage defines a pair of channels in the pair of columns within which the pair of rods are positioned in order to guide the carriage along the pair of rods.
40. A pedal assembly for equipment for electromechanical exercise or rehabilitation of a user, the pedal assembly comprising:
   a base;
   a hub coupled to the base and defines a depression, the hub is configured to be mounted to and rotate with the rotational axle of the equipment;
   at least one rod coupled to the base;
      a carriage linearly and slidably movable along the at least one rod, and the carriage has an aperture to couple to a spindle that supports a pedal;
   a motor coupled to the base and operatively coupled to a leadscrew threadingly engaged with the carriage to linearly move the carriage along the at least one rod relative to the base and perpendicular to the rotational axle when the motor is actuated, and the leadscrew is at least partially positioned within the depression of the hub.
41. The pedal assembly of any clause herein, wherein the at least one rod comprises a first rod and a second rod mounted to the base in parallel, the first rod has a length that is greater than a length of the second rod.
42. The pedal assembly of any clause herein, further comprising a motor mount coupling the motor to the base, the motor mount comprises a center portion extending between a pair of arms, the pair of arms extending from the center portion in parallel, the leadscrew extends through an aperture in the center portion and the pair of arms extend at least partially around the motor.
43. The pedal assembly of any clause herein, wherein the pair of arms comprises a first arm and a second arm, the first arm positioned closer to the first rod than the second arm, the second arm positioned closer to the second rod than the first arm, and the first arm having a length that is greater than a length of the second arm.
44. The pedal assembly of any clause herein, wherein the carriage comprises an arch and a pair of columns extending from the arch in parallel, and a first column of the pair of columns has a length that is greater than a length of a second column of the pair of columns.
45. The pedal assembly of any clause herein, wherein the carriage defines a pair of channels in the pair of columns within which the pair of rods are positioned in order to guide the carriage along the pair of rods.
46. The pedal assembly of any clause herein, wherein the carriage comprises a throughbore that receives the leadscrew and a threaded nut at least partially positioned in the throughbore, and the threaded nut threadingly engages the leadscrew.
47. The pedal assembly of any clause herein, wherein actuation of the motor during a revolution of the drive sub-assembly adjusts a radial position of the carriage relative to the rotational axle to produce a pedal path about the rotational axle.

What is claimed is:

1. An exercise or rehabilitation electromechanical device, comprising:
a drive sub-assembly; and
a pair of pedal assemblies secured to opposing sides of the drive sub-assembly by a rotational axle to rotate with the drive sub-assembly, each pedal assembly comprising:
a base mounted to the rotational axle to rotate with the drive sub-assembly;
a pair of rails mounted to the base in parallel;
a pair of rods coupled to the base in parallel adjacent to but spaced apart from the rails, respectively;
a carriage linearly and slidably movable along the pair of rails and the pair of rods, and the carriage has an aperture to couple to a spindle that supports a respective pedal;
a motor coupled to the base and operatively coupled to a leadscrew threadingly engaged with the carriage to linearly move the carriage along the rails and rods relative to the base and perpendicular to the rotational axle when the motor is actuated; and
a controller for controlling the motor to position the carriage a selected radial distance from the rotational axle.

2. The exercise or rehabilitation electromechanical device of claim 1, wherein the motor comprises:
a housing;
a rotating spindle; and
a planetary gear set positioned within the housing, and the planetary gear set transfers rotation from the spindle to the leadscrew.

3. The exercise or rehabilitation electromechanical device of claim 1, wherein the carriage defines a pair of channels within which the pair of rails and the pair of rods are positioned in order to guide the carriage along the pair of rails and the pair of rods.

4. The exercise or rehabilitation electromechanical device of claim 3, wherein the carriage comprises an arch and a pair of columns extending from the arch such that the arch and the pair of columns define the pair of channels, and the pair of columns is integrally and monolithically connected by the arch.

5. The exercise or rehabilitation electromechanical device of claim 4, wherein the carriage is movable between a first position and a second position spaced apart from the first position, the pair of columns and the arch of the carriage extend at least partially around a space, and the motor is positioned within the space when the carriage is in the first position.

6. The exercise or rehabilitation electromechanical device of claim 1, further comprising a position sensor, wherein the carriage has a path of travel along the pair of rods and is movable between a first position at a first end of the path of travel and a second position at a second end of the path of travel, and the position sensor is configured to detect when the carriage is in the first position or the second position.

7. The exercise or rehabilitation electromechanical device of claim 6, further comprising a second position sensor wherein the position sensor and the second position sensor are each limit switches, and the carriage comprises a notch that contacts the position sensor in the first position, and the notch contacts the second position sensor in the second position.

8. The exercise or rehabilitation electromechanical device of claim 1, wherein the pair of rails or both the pair of rails and the pair of rods are formed with the base as an integral one-piece, monolithic structure.

9. The exercise or rehabilitation electromechanical device of claim 1, wherein the carriage comprises a throughbore that receives the leadscrew and a threaded nut at least partially positioned in the throughbore, and the threaded nut threadingly engages the leadscrew.

10. The exercise or rehabilitation electromechanical device of claim 1, wherein actuation of the motor during a revolution of the drive sub-assembly adjusts a radial position of the carriage relative to the rotational axle to produce a pedal path about the rotational axle.

11. The exercise or rehabilitation electromechanical device of claim 1, further comprising a hub coupling the base to the rotational axle, wherein the hub defines a depression shaped to be complementary to the shape of the leadscrew, and the leadscrew is at least partially positioned within the depression of the hub.

12. The exercise or rehabilitation electromechanical device of claim 1, further comprising:
a pinch barrier mounted to the motor mount and a distal support to cover the leadscrew and the carriage from external exposure; and
a pinch protection plate on an exterior of the pinch barrier and slidably movable with the carriage to cover an aperture in the pinch barrier.

13. A pedal assembly for equipment for electromechanical exercise or rehabilitation of a user, the pedal assembly comprising:
a base configured to be mounted to and rotate with the rotational axle of the equipment;
a pair of rails mounted to the base in parallel;
a pair of rods coupled to the base in parallel adjacent to but spaced apart from the pair of rails, respectively;
a carriage linearly and slidably movable along the pair of rails and the pair of rods, the carriage has an aperture to couple to a spindle that supports a pedal;
a motor coupled to the base for driving a leadscrew to threadingly engage and linearly move the carriage along the rails and rods relative to the base and perpendicular to the rotational axle; and
a controller for controlling the motor to position the pedal a selected radial distance from the rotational axle.

14. The pedal assembly of claim 13, wherein the carriage defines a pair of channels within which the pair of rails and the pair of rods are positioned in order to guide the carriage along the pair of rails and the pair of rods.

15. The pedal assembly of claim 14, wherein the carriage comprises an arch and a pair of columns extending from the arch such that the arch and the pair of columns define the pair of channels, and the pair of columns is integrally and monolithically connected by the arch.

16. The pedal assembly of claim 15, wherein the carriage is movable between a first position and a second position spaced apart from the first position, the pair of columns and the arch of the carriage extend at least partially around a space, and the motor is positioned within the space when the carriage is in the first position.
